(19) United States
(12) Patent Application Publication
(10) Pub. No.: US 2026/0173052 A1
(43) Pub. Date: Jun. 18, 2026

(54) METHOD AND APPARATUS FOR SENDING AND RECEIVING WAKE-UP RESPONSE MESSAGE

(71) Applicant: Beijing Xiaomi Mobile Software Co., Ltd., Beijing (CN)

(72) Inventor: Shengxiang GUO, Beijing (CN)

(73) Assignee: Beijing Xiaomi Mobile Software Co., Ltd., Beijing (CN)

(21) Appl. No.: 19/126,022

(22) PCT Filed: Nov. 4, 2022
(86) PCT No.: PCT/CN2022/130098

§ 371 Date: Apr. 30, 2025

(51) Int. Cl. H04W 72/0453; H04W 52/02; H04W 72/23

(52) U.S. Cl. CPC H04W 72/0453; H04W 52/0229; H04W 72/23

(57) ABSTRACT

A method for sending a wake-up response message includes receiving a wake-up message, and sending the wake-up response message through a first frequency domain resource.

### CROSS-REFERENCE TO RELATED APPLICATION

The present application is a U.S. National Stage of International Application No. PCT/CN2022/130098, filed on Nov. 4, 2022, the entire content of which is incorporated herein by reference for all purposes.

### TECHNICAL FIELD

The present disclosure relates to the field of communication technologies and, specifically, to a method and an apparatus for sending and receiving a wake-up response message.

### BACKGROUND

In the wireless communication system, in order to reduce the power consumption of the terminal device, the 3rd generation partnership project (3GPP) introduces the power saving signal, such as the wake-up signaling (WUS). The WUS signal is a low power detection signal. If the terminal device detects the WUS signal, the terminal device may monitor the physical downlink control channel (PDCCH). If the terminal device does not detect the WUS, the terminal device may skip monitoring of the PDCCH, and thus may be in a low power sleep state, which reduces the power consumption of the terminal device.

### SUMMARY

The present disclosure provides a method and an apparatus for sending and receiving a wake-up response message.

According to a first aspect of embodiments of the present disclosure, there is provided a method for sending a wake-up response message performed by a terminal device. The method includes:
receiving a wake-up message; and
sending the wake-up response message through a first frequency domain resource.

According to a second aspect of the embodiments of the present disclosure, there is provided a method for receiving a wake-up response message performed by a network device. The method includes:
sending a wake-up message; and
receiving the wake-up response message through a first frequency domain resource.

According to a third aspect of the embodiments of the present disclosure, there is provided an apparatus for sending a wake-up response message, including:
a processor; and
a memory, configured to store an instruction executable by the processor; where
the processor is configured to perform steps of the method for sending a wake-up response message provided in the first aspect of the present disclosure.

According to a fourth aspect of the embodiments of the present disclosure, there is provided an apparatus for receiving a wake-up response message, including:
a processor; and
a memory, configured to store an instruction executable by the processor; where
the processor is configured to perform steps of the method for receiving a wake-up response message provided in the second aspect of the present disclosure.

According to a fifth aspect of the embodiments of the present disclosure, there is provided a computer-readable storage medium storing a computer program instruction. The computer program instruction, when executed by a processor, implements steps of the method for sending a wake-up response message provided in the first aspect of the present disclosure.

According to a sixth aspect of the embodiments of the present disclosure, there is provided a computer-readable storage medium storing a computer program instruction. The computer program instruction, when executed by a processor, implements steps of the method for receiving a wake-up response message provided in the second aspect of the present disclosure.

According to a seventh aspect of the embodiments of the present disclosure, there is provided a communication system. The system includes:
a terminal device, configured to perform the method for sending a wake-up response message provided in the first aspect of the present disclosure; and
a network device, configured to perform the method for receiving a wake-up response message provided in the second aspect of the present disclosure.

It should be understood that the above general description and the subsequent detailed description are merely exemplary and explanatory, and cannot limit the present disclosure.

### BRIEF DESCRIPTION OF THE DRAWINGS

The accompanying drawings herein are incorporated into the specification and form a part of the specification, illustrate the embodiments consistent with the present disclosure, and are used in conjunction with the specification to explain the principles of the present disclosure.

FIG. 1 is a schematic diagram of a communication system illustrated according to an exemplary embodiment.

FIG. 2 is a flowchart of a method for sending a wake-up response message illustrated according to an exemplary embodiment.

FIG. 3 is a flowchart of a method for sending a wake-up response message illustrated according to an exemplary embodiment.

FIG. 4 is a flowchart of a method for sending a wake-up response message illustrated according to an exemplary embodiment.

FIG. 5 is a flowchart of a method for receiving a wake-up response message illustrated according to an exemplary embodiment.

FIG. 6 is a flowchart of a method for receiving a wake-up response message illustrated according to an exemplary embodiment.

FIG. 7 is a flowchart of a method for sending and receiving a wake-up response message illustrated according to an exemplary embodiment.

FIG. 8 is a block diagram of a terminal device illustrated according to an exemplary embodiment.

FIG. 9 is a block diagram of a terminal device illustrated according to an exemplary embodiment.

FIG. 10 is a block diagram of a network device illustrated according to an exemplary embodiment.

FIG. 11 is a block diagram of a network device illustrated according to an exemplary embodiment.

FIG. 12 is a block diagram of an apparatus for sending and receiving a wake-up response message illustrated according to an exemplary embodiment.

### DETAILED DESCRIPTION

Exemplary embodiments are described herein in detail, examples of which are indicated in the accompanying drawings. When the following description relates to the accompanying drawings, the same numerals in different accompanying drawings indicate the same or similar elements unless otherwise indicated. The embodiments described in the following exemplary embodiments do not represent all embodiments consistent with the present disclosure. Rather, they are only examples of devices and methods consistent with some aspects of the present disclosure as detailed in the appended claims.

It should be noted that all actions for obtaining signals, information or data in the present disclosure are performed in compliance with the corresponding data protection regulations and policies of the country in the locality, and are performed with authorization granted by the owner of the corresponding device.

In the description of the present disclosure, the terms such as “first”, “second”, and the like as used are used for distinguishing similar objects, and do not necessarily need to be understood as a specific order or sequence. Furthermore, in the description with reference to the accompanying drawings, the same reference numeral in different accompanying drawings indicates the same element in the absence of any indication to the contrary.

In the description of the present disclosure, unless otherwise indicated, “plurality” refers to two or more, and other quantifiers are similar to this. “At least one”, “one or more”, or similar expressions refer to any combination of these ones, including any combination of a single one or plural ones. For example, at least one may indicate any number; as another example, one or more of a, b, and c may indicate: a, b, c, a-b, a-c, b-c, or a-b-c, where a, b, and c may be one or more. “And/or” describes an association relationship between associated objects, indicating that there may be three types of relationships. For example, A and/or B may indicate the following three cases: the existence of A alone, the simultaneous existence of A and B, and the existence of B alone, where A and B may be singular or plural.

In the embodiments of the present disclosure, although operations or steps are described in a particular order in the accompanying drawings, this should not be construed as requiring that the operations or steps be performed in the particular order as shown or in a serial order, or that all of the operations or steps as shown be performed in order to obtain a desired result. In the embodiments of the present disclosure, the operations or steps may be performed serially, or the operations or steps may be performed in parallel; and a part of the operations or steps may be performed.

In the related art, after the terminal device detects the WUS signal, the terminal device may be woken up from the sleep state and monitor the PDCCH. However, the network device cannot determine the sleep state of the terminal device, which affects the reliability of the communication between the terminal device and the network device. In order to overcome the above problems in the related art, the present disclosure provides a method and an apparatus for sending and receiving a wake-up response message.

The following first introduces the environment in which the embodiments of the present disclosure are implemented.

The technical solutions of the embodiments of the present disclosure may be applied to various communication systems. The communication system may include one or more of the following: a 4th generation (4G) communication system, a 5th generation (5G) communication system, and other future wireless communication systems (e.g., 6G). The communication system may also include one or more of the following: a public land mobile network (PLMN) network, a device-to-device (D2D) communication system, a machine to machine (M2M) communication system, an Internet of Things (IoT) communication system, a vehicle-to-everything (V2X) communication system, or other communication systems.

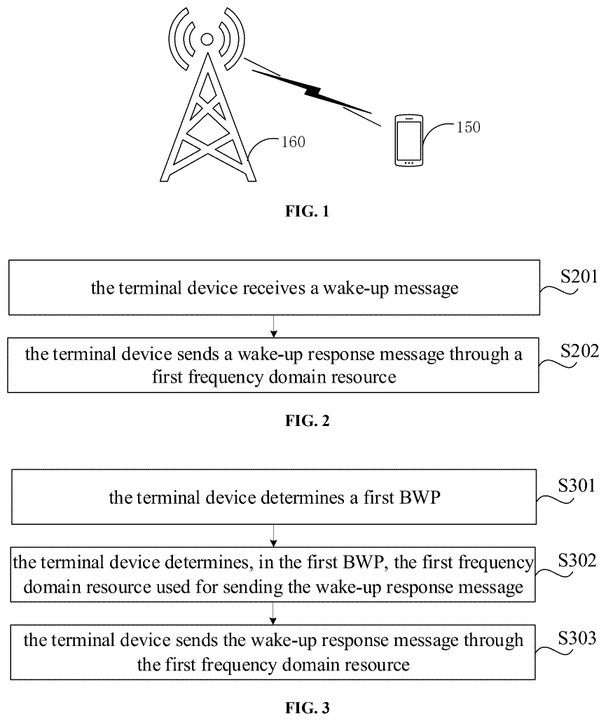

FIG. 1 is a schematic diagram of a communication system illustrated according to an exemplary embodiment. As shown in FIG. 1, the communication system may include a terminal device 150 and a network device 160. The communication system may be used for supporting a 4G network access technology such as a long term evolution (LTE) access technology, or a 5G network access technology such as a new radio access technology (New RAT), or other future wireless communication technologies. It should be noted that in the communication system, the number of the network device and the number of the terminal device may be one or more, the number of the network device and the number of the terminal device of the communication system shown in FIG. 1 are only adaptive examples, and the present disclosure does not make limitations on this.

The network device in FIG. 1 may be used for supporting terminal access, for example, the network device may be an evolutional Node B (eNB, or eNodeB) in the LTE; the network device may also be the next generation Node B (gNB, or gNodeB) in the 5G network; the network device may also be an NG radio access network (NG-RAN) device in the 5G network; the network device may also be a base station in the future evolved PLMN, a broadband network gateway (BNG), an aggregation switch, or a non-3GPP access device, etc. Optionally, the network device in the embodiments of the present disclosure may include various forms of base stations, such as macro base stations, micro base stations (also referred to as small stations), relay stations, access points, 5G base stations or future base stations, satellites, transmitting and receiving points (TRPs), transmitting points (TPs), mobile switching centers, and devices that assume the function of the base station in the communications such as D2D, M2M, IoT, V2X, or other communications, which is not specifically limited in the embodiments of the present disclosure. For convenience of description, in all embodiments of the present disclosure, a device that provides a wireless communication function for the terminal device is collectively referred to as the network device or the base station.

The terminal device in FIG. 1 may be an electronic device that provides voice or data connectivity. For example, the terminal device may also be referred to as a user equipment (UE), a subscriber unit, a mobile station, a station, a terminal, etc. For example, the terminal device may include a smartphone, a smart wearable device, a smart sound box, a smart tablet, a wireless modem, a wireless local loop (WLL) station, a personal digital assistant (PDA), a customer premise equipment (CPE), etc. With the development of wireless communication technologies, a device that can access a communication system, can communicate with a network device of a communication system, and can communicate with other objects through a communication system, or a device that can perform a communication directly between two or more devices may be the terminal device in the embodiments of the present disclosure, such as the terminal and automobile in smart transportation, the household device in smart homes, the power meter reading instrument in smart grids, the voltage monitoring instrument, the environment monitoring instrument, the video monitoring instrument in intelligent security networks, the cash register, and the like. In the embodiments of the present disclosure, the terminal device may communicate with the network device. A plurality of terminal devices may also communicate with each other. The terminal device may be static and fixed, or may be mobile, which is not limited in the present disclosure.

In some embodiments, the terminal device in FIG. 1 may be a terminal device that supports a power saving function. For example, in the absence of data transmission and reception of the terminal device, a primary radio of the terminal device may be in a sleep state of different degrees. In an implementation, the sleep state of the terminal device may include one or more of the following: an ultra-deep sleep state, a deep sleep state, a light sleep state, and a micro sleep state, etc. The time it takes for the primary radio of the terminal device to be woken up from the different sleep states varies. In addition, due to different hardware or software capabilities of the terminal devices themselves, the time it takes for different terminal devices to be woken up from the same sleep state varies.

It should be noted that the terminal device may be in a wake-up state after being woken up, and the wake-up state of the terminal device may be considered as a different state opposite to the sleep state, or may be considered as a special form of the sleep state, which is not limited in the present disclosure.

It should also be noted that the above-described primary radio may include a primary transceiver and/or a primary receiver. The primary transceiver may be one or more, and the primary receiver may be one or more.

The terminal device of FIG. 1 may support receiving a low power WUS signal.

In some embodiments, the terminal device may receive the WUS signal by using the primary radio (the primary transceiver and/or the primary receiver).

In other embodiments, the terminal device may receive a WUS signal by using a separate receiver, and the terminal device may perform downlink signal reception and uplink signal transmission by using the primary transceiver; or may perform the downlink signal reception by using the primary receiver, where the primary receiver and/or the primary transceiver may be referred to as the primary radio of the terminal device. If the terminal device receives a WUS signal indicating the terminal device to be woken up, the terminal device will turn on the primary transceiver for transceiving and processing downlink/uplink information or turn on the primary receiver for receiving and processing the downlink information; if no WUS is received, or if the WUS indicates not waking up, the terminal device will maintain the sleep state of the primary transceiver and/or the primary receiver; where the WUS signal may be applied to the terminal device in any state, such as a radio resource control (RRC) connected state, an RRC idle state, or an RRC deactivated state. In order to enable the terminal device to keep off for a long time, the receiver for receiving the WUS may complete a synchronization function, for example, the synchronization may be achieved through monitoring of a synchronization signal block (SSB).

FIG. 2 is a flowchart of a method for sending a wake-up response message illustrated according to an exemplary embodiment. The method may be performed by the terminal device in the communication system described above. As shown in FIG. 2, the method may include the following steps S201 to S202.
At S201, the terminal device receives a wake-up message.

In some embodiments, the wake-up message may be a message sent by a network device. For example, the wake-up message may be a message or a signal used for indicating the terminal device to change the sleep state. For example, the wake-up message may be a wake-up signaling, or a low power wake-up signaling.
At S202, the terminal device sends a wake-up response message through a first frequency domain resource.

The wake-up response message may also be referred to as a wake-up response signaling, or a low power wake-up response signaling. The wake-up response message may be used for indicating the sleep state of the terminal device.

In some embodiments, the wake-up response message may be used for indicating the network device to determine that the terminal device is woken up from the sleep state.

For example, the terminal device may send, in response to receiving the wake-up message and waking up the primary radio, the wake-up response message to indicate to the network device that the primary radio of the terminal device is woken up and is available for a communication.

In other embodiments, the wake-up response message may be used for indicating that the sleep state of the terminal device is changed.

For example, in response to receiving the wake-up message, the terminal device may change the sleep state from the deep sleep to the light sleep, and send the wake-up response message to indicate to the network device that the sleep state of the terminal device is changed.

In an implementation, the sleep state may be a sleep state of the primary radio of the terminal device. The primary radio may include a primary transceiver and/or a primary receiver.

In another implementation, the sleep state may also be a state of a communication component of the terminal device. The communication component may include the primary radio and/or a wireless modem, etc.

By using the above method, the terminal device receives the wake-up message, and sends the wake-up response message through the first frequency domain resource. In this way, the network device can be indicated through the wake-up response message to determine that the sleep state of the terminal device is changed or the terminal device is woken up, improving the reliability of the communication between the terminal device and the network device.

In some embodiments of the present disclosure, the terminal device may first determine the first frequency domain resource, and then send the wake-up response message through the first frequency domain resource.

In some embodiments, the frequency domain resource may include a resource block (RB), a resource block group (RBG), a resource element (RE), or a resource element group (REG). The above-described first frequency domain resource may include a first RB, a first RBG, a first RE, or a first REG.

The terminal device may determine the first frequency domain resource through any of the following manners.

In manner I, the terminal device determines a second frequency domain resource that receives the wake-up message as the first frequency domain resource.

For example, if the terminal device receives, from the first RB, the wake-up message sent by the network device, the terminal device may determine the first RB as the first frequency domain resource and send the wake-up response message through the first RB.

In this way, without additional signaling indication, the terminal device can determine the first frequency domain resource, and signaling resources can be saved.

In manner II, the terminal device determines the first frequency domain resource based on a first frequency domain indication parameter in a first message as received.

In some embodiments, the first frequency domain indication parameter may include a frequency domain resource index and/or a continuous frequency domain resource indication. In some embodiments, the frequency domain resource index may indicate, in the form of a plurality of bits, a non-contiguous frequency domain resource (where the frequency domain resource may be an RB, an RBG, an RE, or an REG). The frequency domain resource index may also indicate, in the form of a plurality of bits, a continuous frequency domain resource. The continuous frequency domain resource may indicate a continuous frequency domain resource segment through the starting frequency domain position and the number of frequency domain resources. For example, the continuous frequency domain resource indication may include the starting RB position and the number of RBs.

The first message described above may include at least one of the following: the wake-up message, an RRC message, a medium access control control element (MAC CE), and a downlink control information (DCI).

In some embodiments, the number of the first message described above is one. The terminal device may determine the first frequency domain indication parameter through the above-described one first message. For example, the terminal device may obtain the first frequency domain indication parameter from the wake-up message.

In other embodiments, the number of the first message described above is more than one. The terminal device may determine the first frequency domain indication parameter through the above-described plurality of first messages in a joint manner. For example, the first message may include message 1 and message 2. The terminal device may first obtain, based on the received message 1, one or more pending frequency domain resources and a pending identification corresponding to each pending frequency domain resource, and then determine a target identification based on the received message 2, and determine, based on the target identification, the first frequency domain resource from the one or more pending frequency domain resources. For example, a pending frequency domain resource with a pending identification equal to the target identification may be determined as the first frequency domain resource.

The message 1 described above may be any one of the following: an RRC message, a DCI, an MAC CE, and the wake-up message. The message 2 described above may also be any one of the following: an RRC message, a DCI, an MAC CE, and the wake-up message. The message 1 and message 2 described above may be the same type of message or different types of messages.

For example, the message 1 described above may be an RRC message, and the message 2 described above may be a DCI, an MAC CE, or the wake-up message.

As another example, the message 1 described above may be an RRC message or an MAC CE, and the message 2 described above may be a DCI or the wake-up message.

In some embodiments, the message 1 described above may include a system message sent by the network device. For example, the terminal device may determine, by receiving the system message, the first frequency domain resource corresponding to the terminal device.

In this way, the terminal device may flexibly determine the first frequency domain resource through the first message.

In manner III, the terminal device determines the first frequency domain resource from one or more third frequency domain resources supported by the terminal device itself.

In some embodiments, the third frequency domain resource may be a frequency domain resource in a frequency band supported by the capability of the terminal device.

In some embodiments, the third frequency domain resource may be a frequency domain resource (e.g., a frequency band, a frequency point, a cell, a CC, a BWP, or an RB) that the terminal device resides in the current communication network or has used in the current communication network. For example, if the terminal device has resided in a first resident CC in the current communication network, a frequency domain resource in the first resident CC may be determined as the third frequency domain resource. As another example, if the terminal device has used a first activated BWP in the current communication network, a frequency domain resource in the first activated BWP may be determined as the third frequency domain resources.

In some embodiments, the terminal device may randomly select a frequency domain resource from the third frequency domain resource as the first frequency domain resource, or the terminal device may determine a recently used frequency domain resource as the first frequency domain resource.

In this way, the terminal device may determine the first frequency domain resource from one or more third frequency domain resources supported by the terminal device itself.

The terminal device may also use two or three of the above three manners in combination to determine the first frequency domain resource. For example, if the first frequency domain resource is determined based on manner II, the first frequency domain resource is used; if the first frequency domain resource cannot determined based on manner II (e.g., the first message is not received, or the first frequency domain indication parameter is not obtained), the first frequency domain resource may be determined based on the above-described manner I; or if the first frequency domain resource cannot determined based on manner II (e.g., the first message is not received, or the first frequency domain indication parameter is not obtained), the first frequency domain resource may also be determined based on the above-described manner III.

In some embodiments of the present disclosure, when the terminal device and the network device are communicating with each other, one or more component carriers (CCs) may be used. Each CC may include one or more bandwidth parts (BWPs). Each BWP may include one or more frequency domain resources, and the frequency domain resource may be an RB, an RBG, an RE, or an REG.

In some embodiments, the first frequency domain resource may be a frequency domain resource in a first BWP.

In an implementation, the network device may configure N BWPs for the terminal device, and the terminal device may send the wake-up response message to the network device in at least one BWP of the N BWPs, where the wake-up response message may be used for notifying the network device that the terminal device has been woken up, and N may be any integer greater than 0.

In another implementation, the network device may configure the first BWP for the terminal device, or the terminal device may pre-set at least one BWP as the first BWP. The terminal device may send the wake-up response message through the first BWP.

In some embodiments, the first BWP may include at least one of the following: an anchor BWP configured by the network device for the terminal device, a BWP through which the network device sends the wake-up message to the terminal device, all of the current activated BWPs of the terminal device, and a part of the current activated BWPs of the terminal device.

In other embodiments, the first frequency domain resource may also be a frequency domain resource in a first CC.

In an implementation, the terminal device may send the wake-up response message to the network device in M CCs, where the wake-up response message may be used for notifying the network device that the terminal device has been woken up, and M may be any integer greater than 0.

In another implementation, the network device may configure the first CC for the terminal device, or the terminal device may pre-set at least one CC as the first CC. The terminal device may send the wake-up response message through the first CC.

In some embodiments, the first CC may include at least one of the following: an anchor CC configured by the network device for the terminal device, a CC through which the network device sends the wake-up message to the terminal device, all CCs supported by the terminal device, and a part of CCs supported by the terminal device.

In some other embodiments, the first frequency domain resource may also be a frequency domain resource in the first BWP under the first CC.

It should be noted that the first CC may be one or more CCs, the first BWP may be one or more BWPs, and the first frequency domain resource may be one or more frequency domain resources, which is not limited in the present disclosure.

In some embodiments, the terminal device may first determine the first BWP, and then determine, in the first BWP, the first frequency domain resource used for sending the wake-up response message.

In other embodiments, the terminal device may first determine the first CC, then determine the first BWP in the first CC, and finally determine, in the first BWP, the first frequency domain resource used for sending the wake-up response message.

For example, the first BWP may be at least one activated BWP in the first CC. In this way, the terminal device can transmit the wake-up response message described above in at least one activated BWP of the first CC.

FIG. 3 is a flowchart of a method for sending a wake-up response message illustrated according to an exemplary embodiment. As shown in FIG. 3, the method may include the following steps S301 to S303.
At S301, the terminal device determining the first BWP.

In this step, the terminal device may determine the first BWP through any one or more of the following manners.

In an implementation, the terminal device may determine a second BWP that receives the wake-up message as the first BWP.

For example, if the terminal device receives the wake-up message from the second BWP, the terminal device may determine the second BWP as the first BWP.

In another implementation, the terminal device may determine the first BWP based on a first BWP indication parameter in a second message as received.

In some embodiments, the second message may be a message sent by the network device for configuring the first BWP. The second message may be the same as the first message, or may be different from the first message. For example, the second message may include at least one of the following: the wake-up message, an RRC message, an MAC CE, and a DCI.

For example, the second message (e.g., the wake-up message) may include the first BWP indication parameter, and the first BWP indication parameter may be used for indicating an identification or position information of the first BWP.

In another implementation, the terminal device may determine the first BWP from one or more third BWPs that are currently activated.

For example, the terminal device may determine a BWP that is firstly activated as the first BWP.

As another example, the terminal device may determine a latest activated BWP as the first BWP.

As another example, the terminal device may determine a BWP with the lowest or highest center frequency point as the first BWP.

As another example, the terminal device may determine a BWP with the largest or smallest bandwidth as the first BWP.

As another example, the terminal device may determine a BWP with the largest or smallest configured SCS as the first BWP.

As another example, the terminal device may determine an initial BWP of a primary cell (PCell) as the first BWP.

As another example, the terminal device may determine a BWP that receives the wake-up message as the first BWP.

It should be noted that the terminal may determine all of the currently activated BWPs as the first BWP, or may determine a part of the currently activated BWPs as the first BWP.

In this way, the terminal device can determine the first BWP based on one or more of the manners described above.

In some embodiments of the present disclosure, the number of the first BWP described above may be one or more, and the terminal device may further determine, based on a subcarrier spacing (SCS) corresponding to the first BWP, a first SCS corresponding to the first frequency domain resource.

In an implementation, the first SCS corresponding to the first frequency domain resource may be the same as the SCS of the first BWP.

In another implementation, if the number of the first BWP is more than one, and the SCSs of the plurality of first BWPs are different, the first SCS corresponding to the first frequency domain resource may be the largest or smallest SCS in the first BWP.
At S302, the terminal device determines, in the first BWP, the first frequency domain resource used for sending the wake-up response message.

In this step, the terminal device may determine, in the first BWP, the first frequency domain resource through any one or more of the following manners.

In an implementation, the terminal device may determine a second frequency domain resource, in the first BWP, that receives the wake-up message as the first frequency domain resource.

In another implementation, the terminal device may determine, based on a second frequency domain indication parameter in a third message as received, the first frequency domain resource in the first BWP.

In some embodiments, the third message may be a message sent by the network device for configuring the first frequency domain resource in the first BWP. The third message may be the same as the first message, or may be different from the first message.

For example, the third message may include at least one of the following: the wake-up message, an RRC message, an MAC CE, and a DCI.

For example, the third message (e.g., the wake-up message) may include the first resource indication parameter. The first resource indication parameter may be used for indicating position information of the first frequency domain resource in the first BWP.

In another implementation, the terminal device may determine a control resource set (CORESET) frequency domain resource, in the first BWP, used by the terminal device as the first frequency domain resource.

For example, the CORESET frequency domain resource may be a frequency domain resource, in the first BWP, used by a CORESET of the terminal device. The CORESET frequency domain resource may be a resource determined based on configuration information sent to the terminal device by the network device.

The CORESET may include CORESET0. The CORESET0 may be a set of physical resources within a specific frequency domain position in the downlink resource, and is a PDCCH dedicated to sending a decoded system information block (SIB) message.

In yet another implementation, the terminal device may determine an SSB frequency domain resource, in the first BWP, used by the terminal device as the first frequency domain resource.

For example, the SSB frequency domain resource is a frequency domain resource, in the first BWP, used by the SSB of the terminal device. The SSB frequency domain resource may be a resource determined based on configuration information sent to the terminal device by the network device.

In yet another implementation, the terminal device may determine a frequency domain resource corresponding to the first BWP as the first frequency domain resource.

For example, the position of the first frequency domain resource may be the same as the position of the first BWP.

In this way, the terminal device may determine, in the first BWP, the first frequency domain resource used for sending the wake-up response message based on one or more of the manners described above.

In some embodiments, the terminal device may also first determine a pending frequency domain position from the first BWP, determine the pending frequency domain position as a first center frequency domain position, and determine the first frequency domain resource based on the first center frequency domain position.

For example, the terminal device may determine the first frequency domain resource based on the first center frequency domain position and a preset bandwidth. The preset bandwidth may be a frequency domain resource, where the number of the frequency domain resource is a first preset number. For example, the terminal device may determine the first preset number of frequency domain resources centered on the first central frequency domain position as the first frequency domain resource. For example, in the case where the first frequency domain resource is a first RB, the first preset number may characterize the number of the RB; in the case where the first frequency domain resource is a first RE, the first preset number may characterize the number of the RE.

In an implementation, the terminal device may determine a second center frequency domain position of the first BWP as the pending frequency domain position.

In another implementation, the terminal device may determine a third center frequency domain position of a CORESET frequency domain resource used by the terminal device in the first BWP as the pending frequency domain position.

In yet another implementation, the terminal device may determine a fourth center frequency domain position of an SSB frequency domain resource used by the terminal device in the first BWP as the pending frequency domain position.

In yet another implementation, the terminal device may determine a fifth center frequency domain position of a second frequency domain resource used for receiving the wake-up message in the first BWP as the pending frequency domain position.

In this way, based on one or more of the above implementations, the terminal device may determine the pending frequency domain position from the first BWP, determine the pending frequency domain position as the first center frequency domain position, and determine, based on the first center frequency domain position, the first frequency domain resource used for sending the wake-up response message.
At S303, the terminal device sends the wake-up response message through the first frequency domain resource.

For example, the terminal device may send, in response to receiving the wake-up message, the wake-up response message through the first frequency domain resource.

By using the above method, the terminal device may first determine the first BWP, then determine, in the first BWP, the first frequency domain resource used for sending the wake-up response message, and send the wake-up response message through the first frequency domain resource.

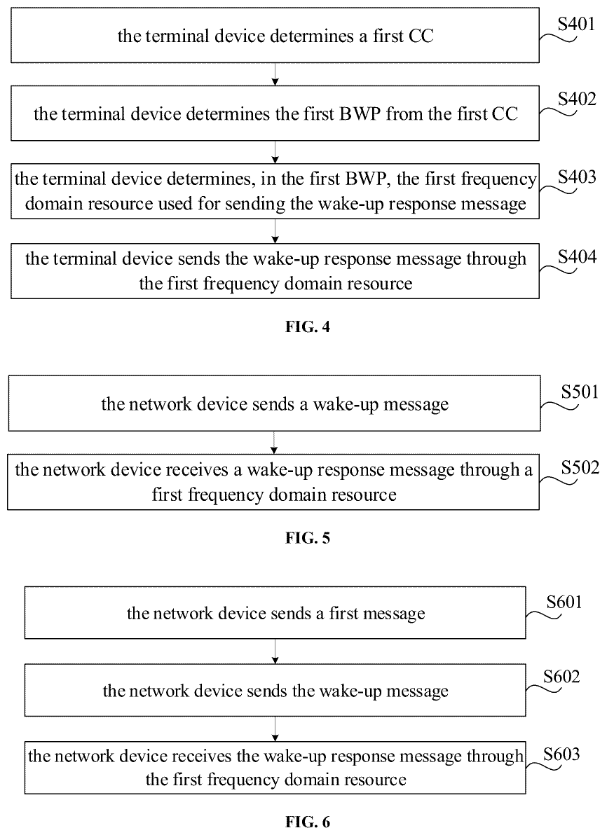

FIG. 4 is a flowchart of a method for sending a wake-up response message illustrated according to an exemplary embodiment. As shown in FIG. 4, the method may include the following steps S401 to S404.
At S401, the terminal device determines the first CC.

In this step, the terminal device may determine the first CC through any one or more of the following manners.

In an implementation, the terminal device may determine a second CC that receives the wake-up message as the first CC.

For example, if the terminal device receives the wake-up message from the second CC, the terminal device may determine the second CC as the first CC.

In another implementation, the terminal device may determine the first CC based on a first CC indication parameter in a fourth message as received.

In some embodiments, the fourth message may be a message sent by the network device for configuring the first CC. The fourth message may be the same as the first message, or may be different from the first message. For example, the fourth message may include at least one of the following: the wake-up message, an RRC message, an MAC CE, and a DCI.

For example, the fourth message (e.g., the wake-up message) may include a first CC indication parameter. The first CC indication parameter may be used for indicating an identification of the first CC.

In another implementation, the terminal device may determine the first CC from one or more third CCs currently activated by the terminal device.

For example, the third CC includes a CC corresponding to the PCell, and the terminal device may determine the CC corresponding to the PCell as the first CC (the first CC may also be referred to as an anchor CC).

As another example, the terminal device may determine a CC, in the third CC described above, with the highest or lowest cell identification as the first CC.

As another example, the terminal device may determine a CC with the highest or lowest center frequency point as the first CC.

As another example, the terminal device may determine a CC with the largest or smallest bandwidth as the first CC.

As another example, the terminal device may determine a CC with the largest or smallest SCS of all configured BWPs as the anchor CC.

It should be noted that the terminal device may determine all of the currently activated CCs as the first CC, or the terminal device may determine a part of the currently activated CCs as the first CC.
At S402, the terminal device determines the first BWP from the first CC.

In this step, the terminal device may determine the first BWP from the first CC through any one or more of the following manners.

In an implementation, the terminal device may determine a BWP, in the first CC, that receives the wake-up message as the first BWP.

In another implementation, the terminal device may determine the first BWP based on a second BWP indication parameter in a sixth message as received.

In some embodiments, the sixth message may be a message sent by the network device for configuring the first BWP in the first CC. The sixth message may be the same as the first message, or may be different from the first message. For example, the sixth message may include at least one of the following: the wake-up message, an RRC message, an MAC CE, and a DCI.

In another implementation, the terminal device may determine the first BWP from one or more third BWPs that are currently activated.

For example, the terminal device may determine a BWP, in the first CC, that is firstly activated as the first BWP.

As another example, the terminal device may determine a latest activated BWP in the first CC as the first BWP.

As another example, the terminal device may determine a BWP, in the first CC, with the lowest or highest center frequency point as the first BWP.

As another example, the terminal device may determine a BWP, in the first CC, with the largest or smallest bandwidth as the first BWP.

As another example, the terminal device may determine a BWP, in the first CC, with the largest or smallest configured SCS as the first BWP.

As another example, the terminal device may determine an initial BWP of a PCell as the first BWP.

As another example, the terminal device may determine a BWP that receives the wake-up message as the first BWP.

It should be noted that the terminal may determine all of the currently activated BWPs in the first CC as the first BWP, or the terminal may determine a part of the currently activated BWPs in the first CC as the first BWP.

In this way, the terminal device can determine, based on one or more of the manners described above, the first BWP from the first CC.
At S403, the terminal device determines, in the first BWP, the first frequency domain resource used for sending the wake-up response message.

It should be noted that the manner in which the terminal device determines the first frequency domain resource from the first BWP may be referred to the implementation of step S302 in the preceding embodiments of the present disclosure, and will not be repeated herein.
At S404, the terminal device sends the wake-up response message through the first frequency domain resource.

For example, the terminal device may send, in response to receiving the wake-up message, the wake-up response message through the first frequency domain resource.

By using the above method, the terminal device may first determine the first CC, then determine the first BWP in the first CC, and finally determine, in the first BWP, the first frequency domain resource used for sending the wake-up response message, and send the wake-up response message through the first frequency domain resource.

In some embodiments of the present disclosure, the terminal device may further determine, based on a first interval parameter, a frequency domain guard interval corresponding to the first frequency domain resource.

In an implementation, the first interval parameter may be a preset interval parameter.

In another implementation, the first interval parameter may be an interval parameter determined in response to a fifth message being received.

In some embodiments, the fifth message may be a message sent by the network device for configuring the first interval parameter. For example, the fifth message may include at least one of the following: the wake-up message, an RRC message, an MAC CE, and a DCI.

In this way, the terminal device can determine the frequency domain guard interval corresponding to the first frequency domain resource.

FIG. 5 is a flowchart of a method for receiving a wake-up response message illustrated according to an exemplary embodiment. The method may be performed by the network device in the communication system described above. As shown in FIG. 5, the method may include the following steps S501 to S502.
At S501, the network device sends a wake-up message.

In some embodiments, the wake-up message may be used for waking up the terminal device. For example, the wake-up message may be a message or a signal used for indicating the terminal device to change the sleep state. For example, the wake-up message may be a wake-up signaling, or a low power wake-up signaling.
At S502, the network device receives a wake-up response message through a first frequency domain resource.

In some embodiments, the wake-up response message may be a message sent by the terminal device, in response to receiving the wake-up message, through the first frequency domain resource. The wake-up response message may also be referred to as a wake-up response signaling or a low power wake-up response signaling. The wake-up response message may be used for indicating the sleep state of the terminal device.

In some embodiments, the network device may determine, based on the wake-up response message, that the terminal device is woken up from the sleep state.

For example, the terminal device may send, in response to receiving the wake-up message and waking up the primary radio, the wake-up response message. In this way, in response to receiving the wake-up response message, the network device may determine that the primary radio of the terminal device is woken up, and the network device can communicate with the terminal device, e.g., can perform scheduling on the terminal device.

In other embodiments, the network device may determine, based on the wake-up response message, that the sleep state of the terminal device is changed.

For example, in response to receiving the wake-up message, the terminal device may change the sleep state from the deep sleep to the light sleep, and send the wake-up response message. In this way, the network device may determine, in response to receiving the wake-up response message, that the sleep state of the terminal device is changed.

By using the above method, the network device may send the wake-up message, and receive the wake-up response message through the first frequency domain resource. In this way, the network device can accurately determine that the sleep state of the terminal device is changed or the terminal device is woken up, improving the reliability of the communication between the terminal device and the network device.

In some embodiments of the present disclosure, the frequency domain resource may include an RB, an RBG, an RE, or an REG. The above-described first frequency domain resource may include a first RB, a first RBG, a first RE, or a first REG.

The network device may determine the first frequency domain resource through any of the following manners.

In manner XI, the network device determines a second frequency domain resource sending the wake-up message as the first frequency domain resource.

For example, if the network device sends the wake-up message from the first RB, the network device may determine the first RB as the first frequency domain resource and receive the wake-up response message through the first RB.

Similarly, the terminal device may determine the second frequency domain resource that receives the wake-up message as the first frequency domain resource.

In this way, without additional signaling indication, the network device and the terminal device can determine the first frequency domain resource by using the same manner, which can save signaling resources.

In manner XII, the network device determines the first frequency domain resource from one or more third frequency domain resources supported by the terminal device.

In some embodiments, the third frequency domain resource may be a frequency domain resource in a frequency band supported by the capability of the terminal device.

For example, the network device may obtain a capability parameter (e.g., a UE capability) of the terminal device, and determine, based on the capability parameter, the third frequency domain resource (e.g., a frequency band or a frequency point) supported by the terminal device.

In some embodiments, the third frequency domain resource may be a frequency domain resource (e.g., a frequency band, a frequency point, a cell, a CC, a BWP, or an RB) that the terminal device resides in the current communication network or has used in the current communication network. For example, if the terminal device has resided in a first resident CC in the current communication network, a frequency domain resource in the first resident CC may be determined as the third frequency domain resource. As another example, if the terminal device has used a first activated BWP in the current communication network, a frequency domain resource in the first activated BWP may be determined as the third frequency domain resources.

For example, the network device may record frequency domain information that the terminal device resides or uses, and determine the third frequency domain resource based on the frequency domain information.

In manner XIII, the network device determines a pre-configured fourth frequency domain resource as the first frequency domain resource.

In this way, the network device can determine the first frequency domain resource through any one or more of the manners described above.

In some embodiments of the present disclosure, after the network device determines the first frequency domain resource through any of the above manners, the network device may notify the terminal device of the first frequency domain resource.

In some embodiments, the above wake-up message may include a first frequency domain resource indication parameter used for indicating the first frequency domain resource.

In this way, the network device may indicate, through the first frequency domain resource indication parameter included in the wake-up message, the terminal device to determine the first frequency domain resource and send the wake-up response message through the first frequency domain resource.

FIG. 6 is a flowchart of a method for receiving a wake-up response message illustrated according to an exemplary embodiment. As shown in FIG. 6, the method may include the following steps S601 to S603.
At S601, the network device sends a first message.

In some embodiments, the first message may include the first frequency domain indication parameter used for indicating the first frequency domain resource.

In some embodiments, the first message may include at least one of the following: an RRC message, an MAC CE, and a DCI.
At S602, the network device sends the wake-up message.
At S603, the network device receives the wake-up response message through the first frequency domain resource.

In this way, the network device may indicate, through the first message, the terminal device to determine the first frequency domain resource, and may receive, through the first frequency domain resource, the wake-up response message sent by the terminal device.

In some embodiments of the present disclosure, when the terminal device and the network device are communicating with each other, one or more CCs may be used. Each CC may include one or more BWPs. Each BWP may include one or more frequency domain resources, and the frequency domain resource may be an RB, an RBG, an RE, or an REG.

In some embodiments, the first frequency domain resource may be a frequency domain resource in the first BWP.

In other embodiments, the first frequency domain resource may also be a frequency domain resource in the first CC.

In yet other embodiments, the first frequency domain resource may also be a frequency domain resource in the first BWP under the first CC.

It should be noted that the first CC may be one or more CCs, the first BWP may be one or more BWPs, and the first frequency domain resource may be one or more frequency domain resources, which is not limited in the present disclosure.

In some embodiments, the network device may send a second message to the terminal device. The second message may include a first BWP indication parameter. The first BWP indication parameter may be used for indicating the terminal device to determine the first BWP.

In some embodiments, the second message may be the same as the first message, or may be different from the first message. The second message may include at least one of the following: the wake-up message, an RRC message, an MAC CE, and a DCI.

In some embodiments, the network device may send a third message to the terminal device. The third message may include a second frequency domain indication parameter. The second frequency domain indication parameter may be used for indicating the terminal device to determine the first frequency domain resource in the first BWP.

Similarly, the third message may be the same as the first message, or may be different from the first message. The third message may include at least one of the following: the wake-up message, an RRC message, an MAC CE, and a DCI.

In some embodiments, the network device may send a fourth message to the terminal device. The fourth message may include a first CC indication parameter. The first CC indication parameter may be used for indicating the terminal device to determine the first CC.

Similarly, the fourth message may be the same as the first message, or may be different from the first message. The fourth message may include at least one of the following: the wake-up message, an RRC message, an MAC CE, and a DCI.

In some embodiments, the network device may send a fifth message to the terminal device. The fifth message may include a first interval parameter. The first interval parameter may be used for indicating the terminal device to determine a frequency domain guard interval corresponding to the first frequency domain resource.

Similarly, the fifth message may be the same as the first message, or may be different from the first message. The fifth message may include at least one of the following: the wake-up message, an RRC message, an MAC CE, and a DCI.

In some embodiments, the network device may send a sixth message to the terminal device. The sixth message may include a second BWP indication parameter. The second BWP indication parameter may be used for indicating the terminal device to determine the first BWP in the first CC.

Similarly, the sixth message may be the same as the first message, or may be different from the first message. The sixth message may include at least one of the following: the wake-up message, an RRC message, an MAC CE, and a DCI.

Through the above method, the network device may indicate the terminal device to determine at least one of the first CC, the first BWP, and the first frequency domain resource, and may receive, through the corresponding frequency domain resource, the wake-up response message sent by the terminal device.

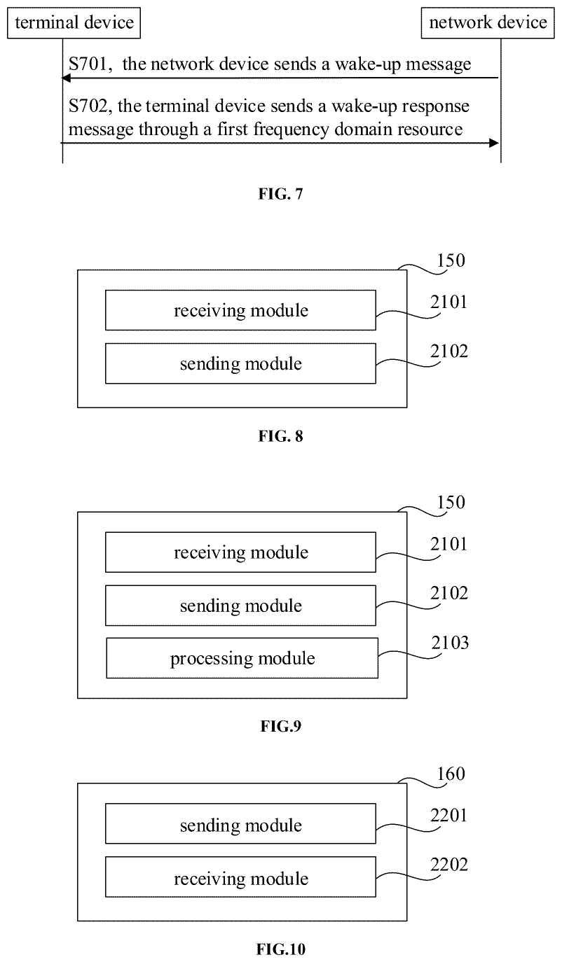

FIG. 7 is a flowchart of a method for sending and receiving a wake-up response message illustrated according to an exemplary embodiment. As shown in FIG. 7, the method may include the following steps S701 to S702.
At S701, the network device sends a wake-up message.
At S702, the terminal device sends a wake-up response message through a first frequency domain resource.

In some embodiments, the terminal device may send, in response to receiving the wake-up message sent by the network device, the wake-up response message through the first frequency domain resource.

In some embodiments, the network device may receive the wake-up response message through the first frequency domain resource.

It should be noted that the specific implementation of the above steps and the determination manner of the first frequency domain resource may be referred to the description in the preceding embodiments of the present disclosure, and will not be repeated herein.

By using the above method, the network device may send the wake-up message and receive the wake-up response message through the first frequency domain resource, and the terminal device sends, in response to receiving the wake-up message, the wake-up response message through the first frequency domain resource. In this way, the network device can accurately determine that the sleep state of the terminal device is changed or the terminal device is woken up, improving the reliability of the communication between the terminal device and the network device.

According to one or more embodiments of the present disclosure, a communication system is provided as shown in FIG. 1. In the communication system shown in FIG. 1, the network device 160 may be configured to send a wake-up message, and receive a wake-up response message through a first frequency domain resource. The terminal device 150 may be configured to send, in response to receiving the wake-up message, the wake-up response message through the first frequency domain resource.

It should be noted that the specific manner in which the network device and the terminal device perform the above operations may be referred to the detailed description in the preceding embodiments of the present disclosure, and will not be repeated herein.

FIG. 8 is a block diagram of a terminal device 150 illustrated according to an exemplary embodiment. As shown in FIG. 8, the terminal device 150 may include:
a receiving module 2101, configured to receive a wake-up message; and
a sending module 2102, configured to send a wake-up response message through a first frequency domain resource.

FIG. 9 is a block diagram of a terminal device 150 illustrated according to an exemplary embodiment. As shown in FIG. 9, the terminal device 150 may further include:
a processing module 2103, configured to determine a second frequency domain resource that receives the wake-up message as the first frequency domain resource, or determine the first frequency domain resource based on a first frequency domain indication parameter in a first message as received, or determine the first frequency domain resource from one or more third frequency domain resources supported by the terminal device.

In some embodiments, the first message includes at least one of the following: the wake-up message, an RRC signaling, an MAC CE, and a DCI.

In some embodiments, the processing module 2103 is further configured to determine a first BWP, and determine, in the first BWP, the first frequency domain resource used for sending the wake-up response message.

In some embodiments, the processing module 2103 is configured to determine a second BWP that receives the wake-up message as the first BWP, or determine the first BWP based on a first BWP indication parameter in a second message as received, or determine the first BWP from one or more third BWPs currently activated by the terminal device.

In some embodiments, the processing module 2103 is configured to: determine a second frequency domain resource, in the first BWP, that receives the wake-up message as the first frequency domain resource; or determine in the first BWP, based on a second frequency domain indication parameter in a third message as received, the first frequency domain resource; or determine a CORESET frequency domain resource, in the first BWP, used by the terminal device as the first frequency domain resource; or determine an SSB frequency domain resource, in the first BWP, used by the terminal device as the first frequency domain resource; or determine a frequency domain resource corresponding to the first BWP as the first frequency domain resource.

In some embodiments, the processing module 2103 is configured to determine a pending frequency domain position from the first BWP, determine the pending frequency domain position as a first center frequency domain position, and determine the first frequency domain resource based on the first center frequency domain position.

In some embodiments, the processing module 2103 is configured to: determine a second center frequency domain position of the first BWP as the pending frequency domain position; or determine a third center frequency domain position of a CORESET frequency domain resource used by the terminal device in the first BWP as the pending frequency domain position; or determine a fourth center frequency domain position of an SSB frequency domain resource used by the terminal device in the first BWP as the pending frequency domain position; or determine a fifth center frequency domain position of a second frequency domain resource used for receiving the wake-up message in the first BWP as the pending frequency domain position.

In some embodiments, the processing module 2103 is configured to determine a first CC, and determine the first BWP from the first CC.

In some embodiments, the processing module 2103 is configured to determine a second CC that receives the wake-up message as the first CC, or determine the first CC based on a first CC indication parameter in a fourth message as received, or determine the first CC from one or more third CCs currently activated by the terminal device.

In some embodiments, a number of the first BWP is one or more, and the processing module 2103 is further configured to determine, based on an SCS corresponding to the first BWP, a first SCS corresponding to the first frequency domain resource.

In some embodiments, the processing module 2103 is further configured to determine, based on a first interval parameter, a frequency domain guard interval corresponding to the first frequency domain resource; where the first interval parameter is a preset interval parameter, or the first interval parameter is an interval parameter determined in response to a fifth message being received.

In some embodiments, the first frequency domain resource includes a first RB, a first RBG, a first RE, or a first REG.

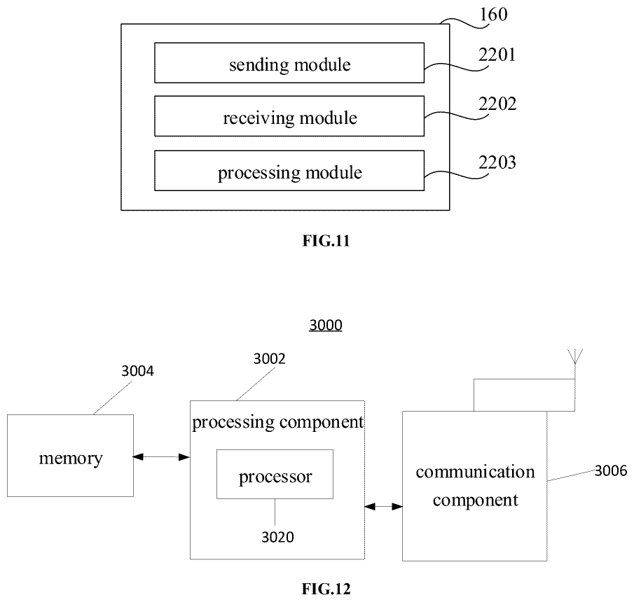

FIG. 10 is a block diagram of a network device 160 illustrated according to an exemplary embodiment. As shown in FIG. 10, the network device 160 may include:
a sending module 2201, configured to send a wake-up message; and
a receiving module 2202, configured to receive a wake-up response message through a first frequency domain resource.

FIG. 11 is a block diagram of a network device 160 illustrated according to an exemplary embodiment. As shown in FIG. 11, the network device 160 may further include:
a processing module 2203, configured to determine a second frequency domain resource sending the wake-up message as the first frequency domain resource, or determine the first frequency domain resource from one or more third frequency domain resources supported by the terminal device, or determine a pre-configured fourth frequency domain resource as the first frequency domain resource.

In some embodiments, the wake-up message includes a first frequency domain resource indication parameter used for indicating the first frequency domain resource.

In some embodiments, the sending module 2201 is further configured to send a first message, where the first message includes a first frequency domain indication parameter used for indicating the first frequency domain resource.

In some embodiments, the first message includes at least one of the following: an RRC message, an MAC CE, and a DCI.

In some embodiments, the first frequency domain resource includes a first RB, a first RBG, a first RE, or a first REG.

With respect to the devices in the above embodiments, the specific manner in which each module performs operations has been described in detail in the embodiments related to the method, and will not be described in detail herein.

FIG. 12 is a block diagram of an apparatus for sending and receiving a wake-up response message illustrated according to an exemplary embodiment. The apparatus 3000 for sending and receiving a wake-up response message may be the terminal device in the communication system shown in FIG. 1, or may be the network device in the communication system.

Referring to FIG. 12, the apparatus 3000 may include one or more of the following components: a processing component 3002, a memory 3004, and a communication component 3006.

The processing component 3002 may be used for controlling the overall operation of the apparatus 3000, such as operations associated with display, telephone calls, data communications, camera operations, and recording operations. The processing component 3002 may include one or more processors 3020 to execute an instruction to complete all or a part of the steps of the method for sending and receiving a wake-up response message described above. In addition, the processing component 3002 may include one or more modules that facilitate the interaction between the processing component 3002 and other components. For example, the processing component 3002 may include a multimedia module to facilitate the interaction between the multimedia component and the processing component 3002.

The memory 3004 is configured to store various types of data to support the operations on the apparatus 3000. Examples of such data include the following: an instruction of any application program or method operated on the apparatus 3000, contact data, phonebook data, messages, pictures, videos, etc. The memory 3004 may be implemented by any type of volatile or non-volatile storage device or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a disk, or a CD-ROM.

The communication component 3006 is configured to facilitate the communication between the apparatus 3000 and other devices in wired or wireless manners. The apparatus 3000 may access a wireless network based on a communication standard, such as the Wi-Fi, the 2G, the 3G, the 4G, the 5G, the 6G, the NB-IOT, the eMTC, or a combination thereof. In an exemplary embodiment, the communication component 3006 receives broadcast signals or broadcast related information from an external broadcast management system through a broadcast channel. In an exemplary embodiment, the communication component 3006 further includes a near-field communication (NFC) module to facilitate short-range communication. For example, the NFC module may be implemented based on the radio frequency identification (RFID) technology, the infrared data association (IrDA) technology, the ultra-wideband (UWB) technology, the Bluetooth (BT) technology, or other technologies.

In an exemplary embodiment, the apparatus 3000 may be implemented by one or more of the following: an application-specific integrated circuit (ASIC), a digital signal processor (DSP), a digital signal processing device (DSPD), a programmable logic device (PLD), a field-programmable gate array (FPGA), a controller, a microcontroller, a microprocessor, or other electronic elements, to perform the method for sending the receiving a wake-up response message described above.

The apparatus 3000 described above may be an independent electronic device, or a part of an independent electronic device. For example, in an embodiment, the electronic device may be an integrated circuit (IC) or a chip. In some embodiments, the integrated circuit may be a single IC, or a set of a plurality of ICs. The chip may include, but is not limited to, the following types: a graphics processing unit (GPU), a central processing unit (CPU), a field programmable gate array (FPGA), a digital signal processor (DSP), an application specific integrated circuit (ASIC), a system on chip (SOC), etc. The above-described integrated circuit or chip may be used for executing an executable instruction (or code) to implement the method for sending and receiving a wake-up response message described above. In some embodiments, the executable instruction may be stored in the integrated circuit or the chip, or may be obtained from other devices or apparatuses. For example, the integrated circuit or the chip includes a processor, a memory, and an interface used for communicating with other devices. The executable instruction may be stored in the processor. When the executable instruction is executed by the processor, the method for sending and receiving a wake-up response message described above is implemented. Alternatively, the integrated circuit or the chip may receive the executable instruction through the interface and transmit the executable instruction to the processor for execution, thereby implementing the method for sending and receiving a wake-up response message described above.

In an exemplary embodiment, the present disclosure further provides a computer-readable storage medium storing a computer program instruction. The program instruction, when executed by a processor, implements steps of the method for sending and receiving a wake-up response message provided in the present disclosure. For example, the computer-readable storage medium may be a non-transitory computer-readable storage medium including an instruction, such as the above memory 3004 including an instruction. The instruction described above is capable of being executed by the processor 3020 of the apparatus 3000 to complete the method for sending and receiving a wake-up response message described above. For example, the non-transitory computer-readable storage medium may be an ROM, a random access memory (RAM), a CD-ROM, a magnetic tape, a floppy disk, or an optical data storage device.

In another exemplary embodiment, there is also provided a computer program product. The computer program product includes a computer program capable of being executed by a programmable device. The computer program is provided with a code part used for performing the method for sending and receiving a wake-up response message described above when executed by the programmable device.

After considering the specification and practicing the present disclosure, those skilled in the art will easily come up with other implementation solutions of the present disclosure. The present application is intended to cover any variations, uses or adaptive changes of the present disclosure, and the variations, uses or adaptive changes follow the general principles of the present disclosure and include common knowledge or commonly used technical means in the technical field that is not disclosed in the present disclosure. The specification and embodiments are only considered exemplary, and the true scope and spirit of the present disclosure are indicated by the following claims.

It should be understood that the present disclosure is not limited to the precise structure which has been described above and illustrated in the accompanying drawings, and that various modifications and alterations may be made without departing from the scope of the present disclosure. The scope of the present disclosure is limited only by the appended claims.

1. A method for sending a wake-up response message, performed by a terminal device, comprising:
receiving a wake-up message; and
sending the wake-up response message through a first frequency domain resource.

2. The method according to claim 1, wherein the first frequency domain resource is determined through any of:
determining a second frequency domain resource that receives the wake-up message as the first frequency domain resource;
determining the first frequency domain resource based on a first frequency domain indication parameter in a first message as received; or
determining the first frequency domain resource from one or more third frequency domain resources supported by the terminal device.

3. The method according to claim 2, wherein the first message comprises at least one of the wake-up message, a radio resource control (RRC) signaling, a medium access control control element (MAC CE), or a downlink control information (DCI).

4. The method according to claim 1, further comprising:
determining a first bandwidth part (BWP); and
determining, in the first BWP, the first frequency domain resource used for sending the wake-up response message.

5. The method according to claim 4, wherein the determining the first BWP comprises:
determining a second BWP that receives the wake-up message as the first BWP;
determining the first BWP based on a first BWP indication parameter in a second message as received; or
determining the first BWP from one or more third BWPs currently activated by the terminal device.

6. The method according to claim 4, wherein the determining, in the first BWP, the first frequency domain resource used for sending the wake-up response message comprises:
determining a second frequency domain resource, in the first BWP, that receives the wake-up message as the first frequency domain resource;
determining in the first BWP, based on a second frequency domain indication parameter in a third message as received, the first frequency domain resource;
determining a control resource set (CORESET) frequency domain resource, in the first BWP, used by the terminal device as the first frequency domain resource;
determining a synchronization signal block (SSB) frequency domain resource, in the first BWP, used by the terminal device as the first frequency domain resource; or
determining a frequency domain resource corresponding to the first BWP as the first frequency domain resource.

7. The method according to claim 4, wherein the determining, in the first BWP, the first frequency domain resource used for sending the wake-up response message comprises:
determining a pending frequency domain position from the first BWP; and
determining the pending frequency domain position as a first center frequency domain position, and determining the first frequency domain resource based on the first center frequency domain position.

8. The method according to claim 7, wherein the determining the pending frequency domain position from the first BWP comprises:
determining a second center frequency domain position of the first BWP as the pending frequency domain position;
determining a third center frequency domain position of a CORESET frequency domain resource used by the terminal device in the first BWP as the pending frequency domain position;
determining a fourth center frequency domain position of an SSB frequency domain resource used by the terminal device in the first BWP as the pending frequency domain position; or
determining a fifth center frequency domain position of a second frequency domain resource used for receiving the wake-up message in the first BWP as the pending frequency domain position.

9. The method according to claim 4, wherein the determining the first BWP comprises:
determining a first component carrier (CC); and
determining the first BWP from the first CC.

10. The method according to claim 9, wherein the determining the first CC comprises:
determining a second CC that receives the wake-up message as the first CC;
determining the first CC based on a first CC indication parameter in a fourth message as received; or
determining the first CC from one or more third CCs currently activated by the terminal device.

11. The method according to claim 4, wherein a number of the first BWP is one or more, and the method further comprises:
determining, based on a subcarrier spacing (SCS) corresponding to the first BWP, a first SCS corresponding to the first frequency domain resource.

12. The method according to claim 1, wherein the first frequency domain resource comprises a first resource block (RB), a first resource block group (RBG), a first resource element (RE), or a first resource element group (REG); or
the method further comprises:
determining, based on a first interval parameter, a frequency domain guard interval corresponding to the first frequency domain resource; wherein the first interval parameter is a preset interval parameter, or the first interval parameter is an interval parameter determined in response to a fifth message being received.

13. (canceled)

14. A method for receiving a wake-up response message, performed by a network device, comprising:
sending a wake-up message; and
receiving the wake-up response message through a first frequency domain resource.

15. The method according to claim 14, wherein the first frequency domain resource is determined through any of:
determining a second frequency domain resource sending the wake-up message as the first frequency domain resource;
determining the first frequency domain resource from one or more third frequency domain resources supported by the terminal device; or
determining a pre-configured fourth frequency domain resource as the first frequency domain resource;
the wake-up message comprises a first frequency domain resource indication parameter used for indicating the first frequency domain resource; or
the first frequency domain resource comprises a first resource block (RB), a first resource block group (RBG), a first resource element (RE), or a first resource element group (REG).

16. (canceled)

17. The method according to claim 14, further comprising:
sending a first message, wherein the first message comprises a first frequency domain indication parameter used for indicating the first frequency domain resource.

18. The method according to claim 17, wherein the first message comprises at least one of a radio resource control (RRC) message, a medium access control control element (MAC CE), or a downlink control information (DCI).

19-21. (canceled)

22. A terminal device, comprising:
a processor; and
a memory, configured to store an instruction executable by the processor; wherein
the processor is configured to:
receive a wake-up message, and send a wake-up response message through a first frequency domain resource.

23. A non-transitory computer-readable storage medium, storing a computer program instruction that, when executed by a processor, causes the processor to perform the method according to claim 1.

24. (canceled)

25. A network device, comprising:
a processor; and
a memory, configured to store an instruction executable by the processor; wherein
the processor is configured to perform the method according to claim 14.

26. A non-transitory computer-readable storage medium, storing a computer program instruction that, when executed by a processor, causes the processor to perform the method according to claim 14.
